(19) United States
(12) Patent Application Publication
(10) Pub. No.: US 2023/0036106 A1
(43) Pub. Date: Feb. 2, 2023

(54) PLUG CONNECTOR PART WITH A SENSOR DEVICE

(71) Applicant: Phoenix Contact E-Mobility GmbH, Schieder-Schwalenberg (DE)

(72) Inventors: Markus Kroner, Schieder-Schwalenberg (DE); Philipp Leifer, Bad Salzuflen (DE)

(21) Appl. No.: 17/791,576

(22) PCT Filed: Dec. 15, 2020
(86) PCT No.: PCT/EP2020/086092

§ 371 Date: Jul. 8, 2022

(30) Foreign Application Priority Data
Jan. 17, 2020 (DE) 10 2020 101 019.2

(51) Int. Cl. H01R 13/639; H01R 13/66; H02J 7/00

(52) U.S. Cl. CPC H01R 13/6397; H01R 13/6683; H02J 7/0042

(57) ABSTRACT

A plug connector part for plug-in connection to an associated mating plug connector part includes: a housing part connectable in a plug-in manner to the mating plug connector part; a locking device for locking the housing part to the mating plug connector part when the locking device is in a locked position; and a sensor device with a sensor for generating a sensor signal that is dependent on a force between the plug connector part and the mating plug connector part when the locking device is in the locked position.

### CROSS-REFERENCE TO PRIOR APPLICATIONS

This application is a U.S. National Phase application under 35 U.S.C. § 371 of International Application No. PCT/EP2020/086092, filed on Dec. 15, 2020, and claims benefit to German Patent Application No. 10 2020 101 019.2, filed on Jan. 17, 2020. The International Application was published in German on Jul. 22, 2021 as WO/2021/144099 under PCT Article 21(2).

### FIELD

The invention relates to a plug connector part for plug-in connection to an associated mating plug connector part, to a system for charging an electric vehicle with a plug connector part, and to a method for operating a system for charging an electric vehicle.

### BACKGROUND

Such a plug connector part comprises a housing part that is to be connected in a plug-in manner to the mating plug connector part, and a locking device for locking the housing part to the mating plug connector part when the locking device is in a locked position.

Such a plug connector part can, for example, be a component part of a charging system for charging an electric vehicle. A plug connector part can, for example, hereby realize a charging socket (inlet) on the side of an electric vehicle, into which charging socket a mating plug connector part in the form of a charging plug (connector) on a charging cable can be plugged in order to in this way establish a connection between the electric vehicle and a charging station and transmit electrical currents for charging the electric vehicle.

However, in principle it is also conceivable to use a plug connector part in another application to transmit currents.

The plug connector part has a locking device which serves to lock the plug connector part in a connected state to the mating plug connector part such that the plug connector part and the mating plug connector part cannot be detached from one another without additional measures. Via such a locking, on the one hand an unintentional separation of the plug connector part and the mating plug connector part from one another can be prevented. In addition, via such a locking it can also be effected that the connection between the plug connector part and the mating plug connector part is released only by an authorized user.

In a method known from DE 10 2017 207 720 A1 for convenient unsecuring of a physical charging cable lock, a transponder is used which communicates with an electric vehicle by means of a radio connection, wherein a locking device for a charging cable is unlocked depending on an authorization by the transponder. Additionally, an acceleration sensor which detects an actuation desire can be integrated into a charging socket or a charging plug.

DE 10 2012 216 335 A1 describes a charging device in which a force sensor for measuring a force on a charging cable is arranged on the charging cable.

### SUMMARY

In an embodiment, the present invention provides a plug connector part for plug-in connection to an associated mating plug connector part, comprising: a housing part connectable in a plug-in manner to the mating plug connector part; a locking device configured to lock the housing part to the mating plug connector part when the locking device is in a locked position; and a sensor device with a sensor configured to generate a sensor signal that is dependent on a force between the plug connector part and the mating plug connector part when the locking device is in the locked position.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic representation of an electrically operated vehicle (electric vehicle) with a charging cable and a charging station for charging;

FIG. 2 is a schematic view of a plug connector part together with an associated mating plug connector part;

FIG. 3 is a view of an exemplary embodiment of a plug connector part in the form of a charging socket on the side of an electric vehicle;

FIG. 4 is a view of an exemplary embodiment of a sensor device;

FIG. 5 is a view of another exemplary embodiment of a sensor device;

FIG. 6 is a view of an exemplary embodiment of a plug connector part in the form of a charging socket;

FIG. 7 is a view of a fastening device of the plug connector part with a sensor device arranged thereon;

FIG. 8 is a view of a fastening device of the plug connector part with a sensor device arranged thereon, according to another exemplary embodiment;

FIG. 9A is a schematic diagram of a connection of a plug connector part to an associated mating plug connector part;

FIG. 9B shows the view according to FIG. 9A, upon a change in position (exaggerated representation) of the plug connector part in relation to the mating plug connector part;

FIG. 10A is a schematic diagram of a connection of a plug connector part to an associated mating plug connector part, according to another exemplary embodiment of a sensor device; and

FIG. 10B shows the view according to FIG. 10A, upon a change in position (exaggerated representation) of the plug connector part in relation to the mating plug connector part.

### DETAILED DESCRIPTION

In an embodiment, the present invention provides a plug connector part for plug-in connection to a mating plug connector part, as well as a system for charging an electric vehicle and a method for operating a system for charging an electric vehicle, which enable simple, safe handling, in particular for separating the plug connector part from the mating plug connector part.

Arranged on the plug connector part is a sensor device which serves to generate a sensor signal that is correlated with the force between the plug connector part and the mating plug connector part, which can thus be evaluated in order to deduce a force or change in force between the plug connector part and the mating plug connector part. If the plug connector part is locked to the mating plug connector part, i.e., the locking device is in its locked position, a force acting between the plug connector part and the mating plug connector part can indicate an actuation desire of a user for detaching the plug connector part and the mating plug connector part from one another so that the locking device can be controlled, depending on the sensor signal of the sensor device, for example in order to transition the locking device into its unlocked state and to thus enable a detachment of the plug connector part from the mating plug connector part.

Different scenarios are hereby conceivable.

An evaluation of the sensor signal can thus be used to enable a user to detach the plug connector part from the mating plug connector part in a simple, convenient manner, for example in order to end a charging process for charging an electric vehicle. An authorization of a user can, for example, hereby take place wirelessly via an authorization device, for example in the form of a radio key that is to be actively actuated, or in the form of a wirelessly readable authorization token (in the context of what are known as keyless entry systems, for example). If a user is authorized and it is determined that a force is acting between the plug connector part and the mating plug connector part, the locking device can be controlled and thereby unlocked so that a user can separate the plug connector part and the mating plug connector part from one another.

An evaluation of the sensor signal of the sensor of the sensor device can also be used to increase the security against unauthorized access to the plug connector part. If no authorization of a user takes place, for example via a radio key or an authorization token, an unauthorized access can thus be deduced if a force acts between the plug connector part and the mating plug connector part. If the force acting between the plug connector part and the mating plug connector part exceeds a predetermined threshold value, for example, an alarm can be triggered, for example, in that an alarm system of the electric vehicle is activated.

An evaluation of the sensor signal of the sensor of the sensor device can also be used for component protection. By evaluating the sensor signal, and thus by determining a force acting between the plug connector part and the mating plug connector part, it can thus be detected whether an (impermissibly) high load may be present at the locking device, for example due to the effect of gravity given heavy plug connectors or given a canted connection, so that an unlocking of the locking device is prevented in such an event. Only given reduction of the force acting between the plug connector part and the mating plug connector part, and a relief of a locking device as a consequence thereof, determined via the sensor device and the evaluation of the sensor signal, is the locking device then, for example, controlled to unlock, wherein a user can be notified, for example via an acoustic or optical signal, about a load between the plug connector part and the mating plug connector part that is preventing unlocking.

The sensor of the sensor device can, for example, be realized by an FSR sensor, a piezo sensor, a capacitive sensor, or a strain gauge. An FSR sensor (“FSR” stands for the term “force sensing transistor” (protected by trademark law in the US)) is a force sensor using an electrical resistance, which changes its resistance value under the action of pressure or other force. A piezo sensor (short for piezoelectric sensor) can be designed as a pressure sensor, and transduces an applied mechanical signal into an electrical voltage signal. By means of a capacitive sensor, a sensor signal can be generated that is correlated with a force to be measured, for example in that a distance between electrodes of the sensor changes under the action of force. Upon deformation, a strain gauge changes its electrical resistance so that a force causing the deformation can be deduced using a sensor signal generated using the strain gauge.

In one embodiment, the housing part has a wall which faces toward the mating plug connector part when the plug connector part is connected in a plug-in manner to the mating plug connector part, wherein the sensor device is arranged on the wall. In this instance, the sensor device is designed to enter into interaction with the mating plug connector part, for example in that the sensor device is arranged on a plug-in segment of the plug connector part, which segment enters into interaction with the mating plug connector part when the connection is plugged in. In this instance, a force acting between the plug connector part and the mating plug connector part is directly measured via the sensor device.

In another embodiment, the plug connector part can have a fastening device for fastening the plug connector part to a support assembly, wherein the sensor device is arranged on the fastening device. The plug connector part can, for example, have fastening eyes which are formed on the housing part, via which fastening eyes the plug connector part can be connected to the associated support assembly, for example a body segment of an electric vehicle. The sensor device can hereby be designed to measure a force between the fastening device and the support assembly, or a force in the other flux of force between the support assembly and the mating plug connector part. In that a force is measured via the sensor device in the flux of force, a force acting between the plug connector part and the mating plug connector part, or a force change, can be deduced through such a force measurement.

In one embodiment, the sensor device has an active element which is designed to interact with the mating plug connector part when the plug connector part is connected to the mating plug connector part. The active element can, for example, be designed to be elastic at least in segments so that the active element can be elastically deformed given a force acting between the plug connector part and the mating plug connector part, wherein a sensor signal that is correlated with a force acting between the plug connector part and the mating plug connector part can be generated via the sensor device depending on such an elastic deformation.

The sensor can be arranged on the active element, for example.

For example, the active element can have an elastically deformable spring arm which has an abutment element for interacting with the mating plug connector part. Given a force acting between the plug connector part and the mating plug connector part and, given a (slight) change in position between the plug connector part and the mating plug connector part, a deflection occurs at the spring arm, which results in the generation of a sensor signal at the sensor device and which can be evaluated in order to deduce a force or force change between the plug connector part and the mating plug connector part.

The abutment element can, for example, be realized by a bevel that is formed on the spring arm and onto which the mating plug connector part can run when it is being connected in a plug-in manner to the plug connector part. The spring arm thus comes into abutment with the mating plug connector part via the abutment element, so that a deflection on the spring arm occurs given a change in position between the plug connector part and the mating plug connector part, which deflection can be captured by the sensor device and evaluated.

In one embodiment, the sensor is arranged on the spring arm. For example, a sensor designed as a strain gauge can measure a deformation at the spring arm and thus generate a sensor signal that is correlated with a force acting on the spring arm, which force in turn depends on a force acting between the plug connector part and the mating plug connector part.

In one embodiment, the sensor device has a support segment, wherein the sensor is arranged on the support segment. In this instance, the spring arm is designed to interact with the sensor. In this instance, the sensor can be designed, for example, as a capacitive sensor or as a piezoelectric sensor, wherein a change in position between the spring arm and the support segment or a change in pressure between the spring arm and the support segment can be captured and measured via the sensor device in order to deduce a force acting between the plug connector part and the mating plug connector part.

In one embodiment, a system for charging an electric vehicle has a plug connector part of the type described above, and a control device. The control device is designed to evaluate a sensor signal generated by the sensor of the sensor device, and to control the locking device, depending on the sensor signal generated by the sensor, to transition from the locked position to an unlocked position. An unlocking of the locking device thus takes place depending on the sensor signal generated by the sensor device. If a force acting between the plug connector part and the mating plug connector part is determined, which, for example, indicates an actuation desire of a user, the locking device can be controlled to release the locking so that a user can separate the plug connector part and the mating plug connector part from one another.

Using the sensor device, an absolute force between the plug connector part and the mating plug connector part can be determined via evaluation by means of the control device. However, it is in particular also conceivable to determine a relative force change in order to deduce, by evaluating the sensor signal, whether a force currently acting between the plug connector part and the mating plug connector part changes, which may possibly indicate an actuation desire of a user. The decisive factor may thereby not be that the force acting between the plug connector part and the mating plug connector part is determined exactly. Rather, in one embodiment it is important that a force change, for example due to a change in position of the plug connector part in relation to the mating plug connector part, results in a sensor signal or a detectable change in the sensor signal generated by the sensor of the sensor device, which sensor signal can be evaluated accordingly and allows a conclusion to be drawn that a force between the plug connector part and the mating plug connector part has changed.

For example, the control device can be designed to control the locking device to transition to the unlocked position when the measurement value representing the force change exceeds a threshold value. If the value of the force change, which value is output by the sensor device, exceeds a predetermined threshold value, it is assumed that an actuation desire of a user is present, so that the locking device is controlled to unlock.

In one embodiment, the control device is designed to control the locking device depending on the sensor signal and depending on authorization information to authorize a user. The control device thus evaluates whether, for example, a sufficiently large force change occurs at the plug connector part and whether an authorization of a user has additionally taken place. Only if the sensor signal of the sensor device indicates an actuation desire of a user and an authorization has additionally taken place is the locking device controlled to unlock so that a user can release the connection between the plug connector part and the mating plug connector part.

An authorization can, for example, take place wirelessly, for example using an authorization device in the form of a radio key or an authorization token. An authorization token can be read out wirelessly, for example, so that the control device receives authorization information as soon as a user with an authorized authorization token is located in the vicinity of the electric vehicle. The authorization can thus take place automatically and without involvement of a user.

In an embodiment, the invention provides a method for operating a system for charging an electric vehicle. The electric vehicle has a plug connector part that can be connected in a plug-in manner to an associated mating plug connector part, with a housing part, that is to be connected in a plug-in manner to the mating plug connector part, and a locking device. In the method, the housing part of the plug connector part is locked to the mating plug connector part via the locking device. In the method, it is furthermore provided that a sensor of a sensor device of the plug connector part generates a sensor signal that is dependent on a force between the plug connector part and the mating plug connector part when the locking device is in the locked position. Depending on the sensor signal generated by the sensor, the locking device is controlled to transition from a locked position into an unlocked position.

The advantages and advantageous embodiments described above for the plug connector part and the system for charging an electric vehicle are also applied analogously to the method.

The idea behind the invention is explained in more detail below on the basis of the exemplary embodiments shown in Figures. The following is shown:

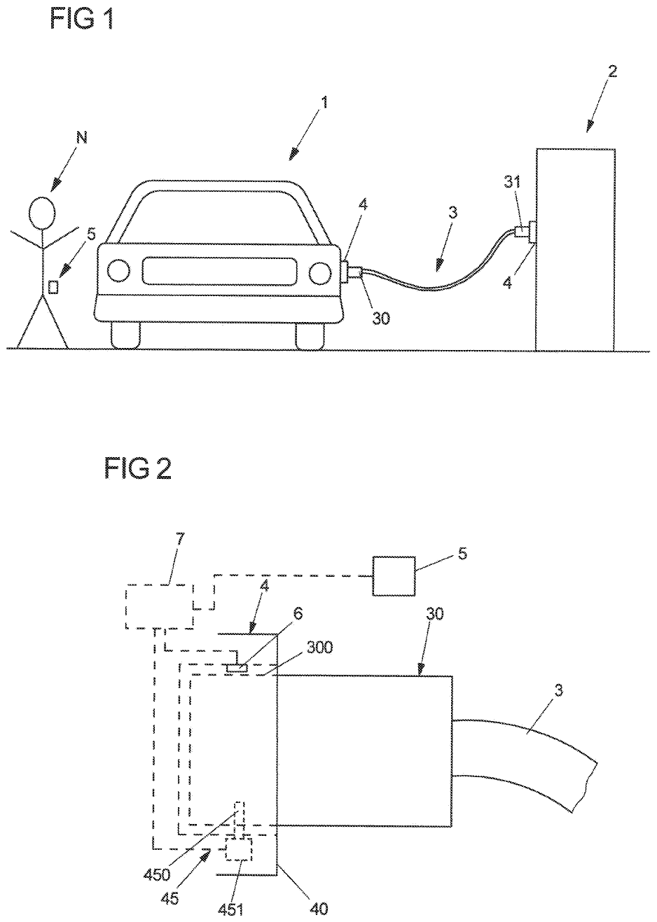

FIG. 1 shows in a schematic view a vehicle 1 in the form of a vehicle powered by an electric motor (also referred to as an electric vehicle). The electric vehicle 1 has electrically chargeable batteries via which an electric motor for moving the vehicle 1 can be electrically supplied.

In order to charge the batteries of the vehicle 1, the vehicle 1 can be connected to a charging station 2 via a charging cable 3. For this purpose, the charging cable 3 can be plugged, with a plug connector part 30 in the form of a charging plug at one end, into an associated plug connector part 4 in the form of a charging socket of the vehicle 1, and is connected at its other end via a plug connector part 31 to a plug connector part 4 of the charging station 2. Charging currents of comparatively high amperage are transmitted via the charging cable 3 to the vehicle 1 in order to charge the vehicle 1.

As is schematically illustrated in FIG. 2 using the example of the plug connector part 4 in the form of the charging socket on the side of the vehicle 1, and of the plug connector part 30 in the form of the charging plug on the charging cable 3, in the connected state the plug connector parts 4, 30, 31 are in engagement with one another such that both a mechanical connection and an electrical contacting for transmitting charging currents are established.

In the shown example, the plug connector part 4 (which can be designed identically on the sides of the vehicle 1 and of the charging station 2) forms a plug-in opening in a housing part 40, into which plug-in opening the associated plug connector part 30 can be plugged with a plug-in segment 300. Inside the plug-in opening, electrical contact elements on the plug-in segment 300 make contact with contact elements of the plug connector part 4 so that an electrical connection is established between the plug connector parts 4, 30.

As is shown schematically in FIG. 2, a locking device 45 can, for example, be provided on the plug connector part 4 on the side of the vehicle 1 (but likewise also on the plug connector part 4 on the side of the charging station 2), which locking device 45 serves to establish a locking between the plug connector part 4 and the plug connector part 30 in the connected position, so that the plug connector parts 4, 30 are mechanically secured to one another and cannot be detached from one another without further measures, in any event not without the locking being released. For this purpose, the locking device 45 can have, for example, a locking element 450, for example in the form of a pin, which can be adjusted via an actuating drive 451 and, in a locked position, is mechanically engaged with the plug connector part 30, in particular the plug-in segment 300 of the plug connector part 30, such that the connection between the plug connector parts 4, 30 is secured.

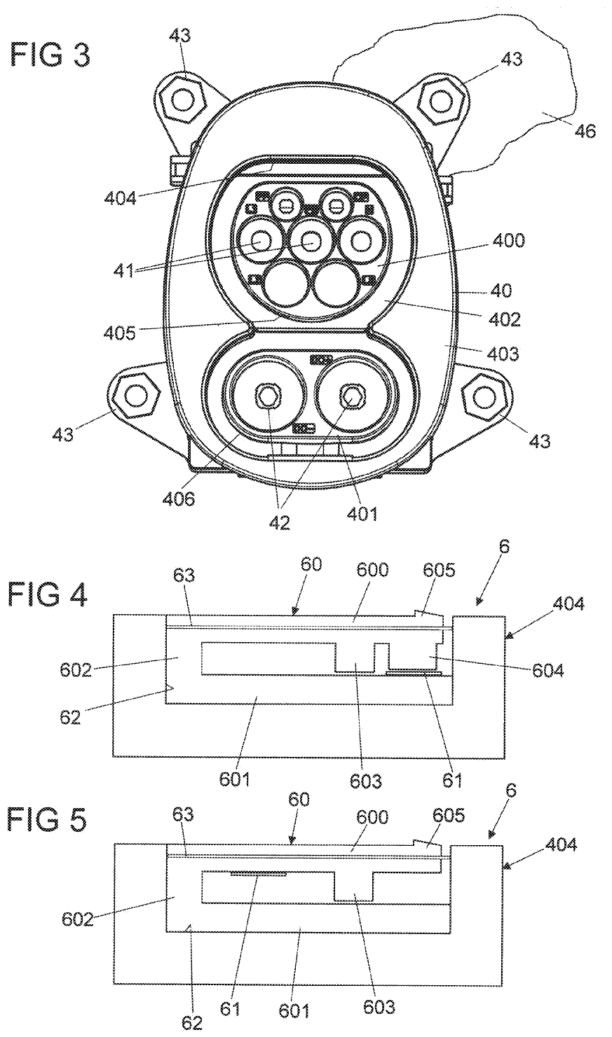

FIG. 3 shows an exemplary embodiment of a plug connector part 4 in the form of a charging socket, which is fixed via fastening devices 43 in the form of fastening eyes to an associated support assembly 46 of the vehicle 1, for example, and is thus fixedly mounted via the fastening devices 43. In the shown exemplary embodiment, plug-in segments 400, 401 are formed on the housing part 40, on which are arranged respective contact elements 41, 42 for plug-in connection with associated contact elements of the plug connector part 30. The plug-in segments 400, 401 are, via an intermediate space 402, spaced apart from a surrounding wall 404 of an aperture segment 403 of the housing part 40 so that the associated plug connector part 30 can be plugged into the intermediate space 402 for plug-in connection.

As can be seen from FIG. 2 in conjunction with FIG. 3, the plug connector part 4 has a sensor device 6 which is designed to generate a sensor signal that is dependent on a force acting between the plug connector part 4 and the associated plug connector part 30, 31 and, for example, is arranged on the wall 404 above the plug-in segment 400 (i.e., a side, facing away from the plug-in segment 401, of the plug-in segment 400); on a wall 405 on a side, facing toward the plug-in segment 401, of the plug-in segment 400; or on a wall 406 on a side, facing away from the plug-in segment 400, of the plug-in segment 401, and serves to interact with the plug-in segment 300 of the mating plug connector part 30 in order to in this way generate a sensor signal that depends on a force acting between the plug connector part 4 and the plug connector part 30 and is thus suitable for indicating a force acting between the plug connector part 4 and the plug connector part 30.

As shown in an exemplary embodiment in FIG. 4, such a sensor device 6 can, for example, have an active element 60 which is received in a receiving opening 62 of, for example, an associated wall 404 of the housing part 40 and forms an elastically deflectable spring arm 60. The active element 60 is supported via a support segment 601 in the receiving opening 62, wherein the spring arm 600 is connected via a connection segment 602 to the support segment 601 and is elastically deflectable in relation to the support segment 601.

On a side facing away from the support segment 601, the spring arm 600 forms an abutment element 605 in the form of a bevel which is designed to interact with the plug-in segment 300 of the plug connector part 30 when the plug connector parts 4, 30 are being connected in a plug-in manner, so that the spring arm 600 can be deflected by the plug connector part 30 and a sensor signal can thus be generated via the sensor device 6, which sensor signal depends on an interaction between the plug connector part 4 and the plug connector part 30.

In the exemplary embodiment illustrated in FIG. 4, a sensor 61 in the form of, for example, a piezoelectric sensor or a capacitive sensor is arranged on the support segment 601. Given a change in position of the spring arm 600 in relation to the support segment 601, a change in pressure at the sensor 61 occurs by the action of a punch 604 formed on the spring arm 600 (given embodiment as a piezoelectric sensor), or a change in distance between the punch 604 and the sensor 61 occurs (given embodiment as a capacitive sensor), so that a sensor signal is generated by the sensor 61 depending on a change in position of the spring arm 600 in relation to the support segment 61.

In the illustrated exemplary embodiment, a path limiting segment 603 is formed on the spring arm 601, which segment serves to prevent an excessive deflection at the spring arm 600.

A sealing element 63 serves to seal the receiving opening 62 toward the outside such that no moisture and no dirt can enter the region of the sensor 61.

In the exemplary embodiment of a sensor device 6, as shown in FIG. 5, an active element 60 which substantially corresponds to the active element 60 according to FIG. 4 is received in a receiving opening 62, for example in the wall 404. A sensor 61 in the form of a strain gauge is arranged at a spring arm 600 and is designed to sense a deformation on the spring arm 600 and to convert it into a sensor signal. An abutment element 605 for interacting with the plug-in segment 300 of the plug connector part 30 is in turn formed on the spring arm 600. A path limiting segment 603 serves to limit the deflection of the spring arm 600 relative to a support segment 601 received in the receiving opening 62 and connected with the spring arm 600 via a connection segment 602. A sealing element 63 seals the receiving opening 62 toward the outside.

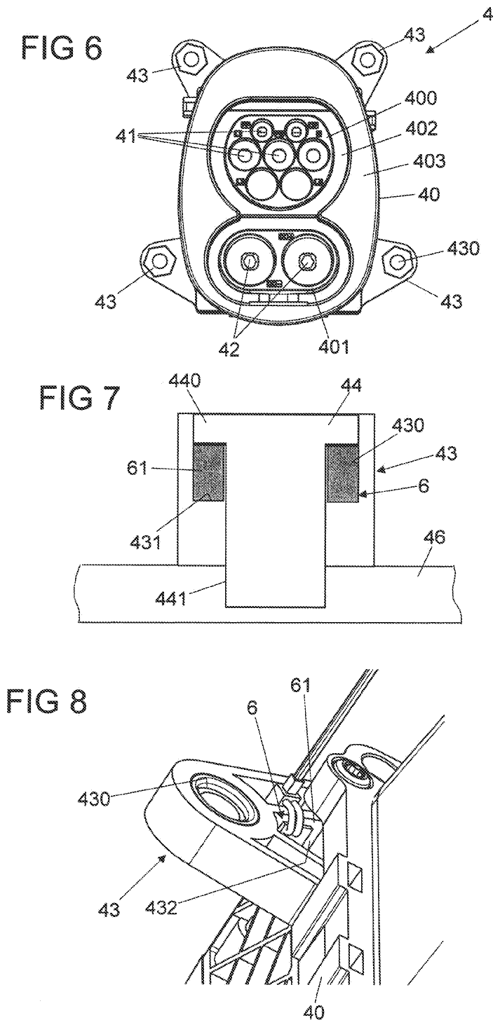

While the sensor device 6 of the exemplary embodiments according to FIGS. 4 and 5 serves to interact with the plug connector part 30, in particular the plug-in segment 300, in an exemplary embodiment of a sensor device 6 shown in FIG. 7, a sensor 61 is arranged on a fastening device 43 of the plug connector part 4 shown in FIG. 6. The sensor 61 can, for example, be received between a head 440 of a fastening element 44 and a shoulder 431 of a fastening opening 430 of the fastening device 43, so that a force on the fastening device 43 can be detected via the sensor 61. The fastening element 44 hereby engages with a shaft 441 in a support assembly 46 and, via it, fixes the fastening device 43 to the support assembly 46.

In the exemplary embodiment according to FIG. 7, a sensor signal is thus not captured directly between the plug connector part 4 and the associated plug connector part 30. Instead, a sensor signal is measured in the flux of force of the connection of the plug connector part 4 to the plug connector part 30. Given a force acting between the plug connector part 4 and the plug connector part 30, there is (also) a force acting on the fastening devices 43 via which the plug connector part 4 is connected to the associated support assembly 46, which can be measured at the fastening devices 43 via one or more sensor devices 6 and evaluated.

In another embodiment, shown in an exemplary embodiment in FIG. 8, a sensor device 6 with a sensor 61, for example in the form of a strain gauge, can also be arranged at a strut element 432 connected to the fastening device 43, in order to measure a deformation in the region of the fastening device 43. In turn, analogous to the exemplary embodiment according to FIG. 7, a sensor signal is captured in the flux of force of the connection of the plug connector part 4 to the plug connector part 30, wherein the sensor signal can be evaluated in order to deduce a force acting between the plug connector part 4 and the plug connector part 30.

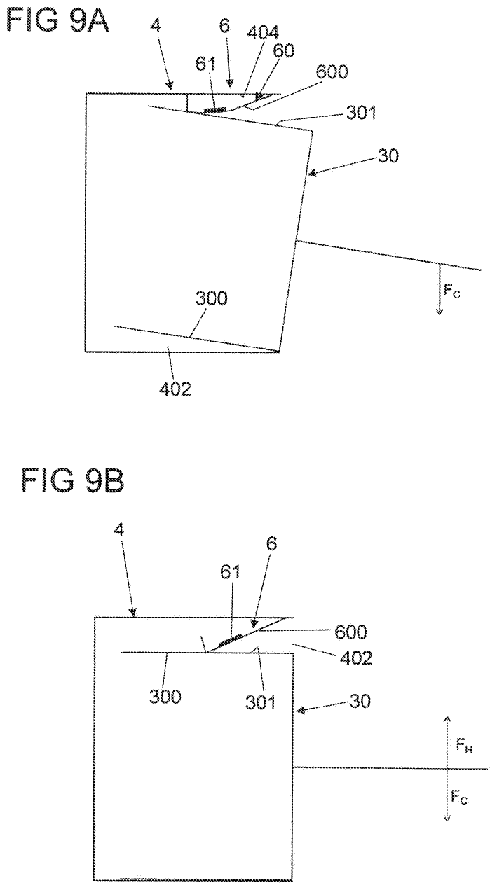

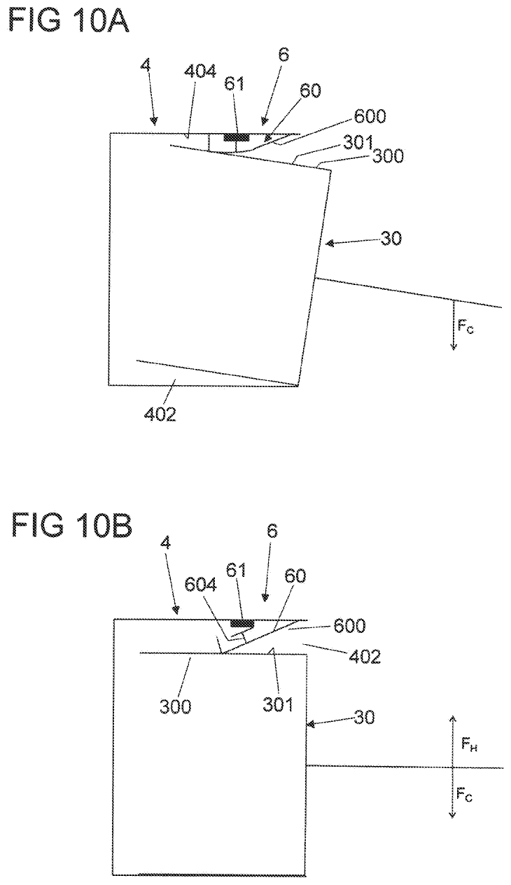

By using the sensor device 6, in particular a force change in the connection between the plug connector part 4 and the associated plug connector part 30 can be deduced, as is illustrated schematically in FIG. 9A, 9B and FIG. 10A, 10B, respectively in an exaggerated manner. FIG. 9A, 9B hereby illustrate the function for the exemplary embodiment according to FIG. 5. FIG. 10A, 10B illustrate the function for the exemplary embodiment according to FIG. 4.

For example, the sensor device 6 can rest with a spring arm 600 on a wall 301 of the plug-in segment 300 of the plug connector part 30, and be deflected in different ways depending on the position of the plug connector part 30 in relation to the plug connector part 4. A deformation at the spring arm 600 can be captured via a sensor 61 at the spring arm 600 (for example in the form of a strain gauge in the example according to FIGS. 9A and 9B), or via interaction of the spring arm 600 with a sensor 61 arranged in a stationary manner in relation to the wall 404 (in the example according to FIGS. 10A and 10B), wherein a sensor signal generated by the sensor 61 can be evaluated in order to determine a force acting on the spring arm 600.

In a rest position, shown in FIGS. 9A and 10A, the plug connector part 30 with the plug-in segment 300 can, for example, be slightly tilted in a plug-in opening of the plug connector part 4, under the action of gravity FC acting on the plug connector part 30. If a user takes hold of the plug connector part 30, the position of the plug connector part 30 in relation to the plug connector part 4 can change, as shown in FIGS. 9B and 10B, which is accompanied by a force change at the sensor device 6 and can be evaluated accordingly via the sensor signal of the sensor device 6.

For example, a user intervention can counteract the gravitational force (force action FH) and a tilt can thus be reduced, so that the spring arm 600, as shown in FIG. 9B, adjusts due to its elasticity. However, it is also conceivable that a user acts on the plug connector part 3 in the direction of gravity and a deflection at the spring arm 600 is thus even increased.

A change in the deflection of the spring arm 600 is detected via the sensor 61 and transduced into a sensor signal which thus indicates a force change at the sensor device 61, and thus in the connection between the plug connector part 4 and the plug connector part 30.

A sensor signal generated via the sensor device 6 can be evaluated by a control device 7 shown schematically in FIG. 2, for example in order to determine a force change in the connection between the plug connector part 4 and the plug connector part 30 and to deduce an actuation desire of a user to release the connection between the plug connector part 4 and the plug connector part 30, for example upon exceeding a threshold value.

For example, the control device 7 can hereby interact with an authorization device 5, for example in the form of a radio key or a wirelessly readable authorization token of a user (see FIG. 1), so that the control device 7 can obtain authorization information for authorizing a user. If such authorization information is available and if, given a force change, detected via the sensor device 6, in the connection between the plug connector part 4 and the plug connector part 30, an actuation desire is deduced, the control device 7 can control the locking device 45 to unlock in order to in this way enable a release of the connection of the plug connector part 4 and the plug connector part 30 from one another.

If no authorization is present but an (excessive) force acting between the plug connector part 4 and the plug connector part 30 is determined, the locking device 45 can be locked so that the connection between the plug connector parts 4, 30 cannot be released in an unauthorized manner. In addition, an alarm system of the vehicle 1 may be controlled by means of the control device 7 in order to trigger an alarm.

Via evaluation by means of the control device 7, it can also be deduced that a load between the plug connector parts 4, 30 is present in particular at the locking device 45 and could result in a release of the lock, possibly leading to damage to the locking device 45. In this event, using an evaluation of the sensor signal of the sensor device 6, an unlocking of the locking device 45 can only be effected if the load on the locking device 45 is reduced via user intervention so that an unlocking of the locking device 45 is possible without damage. Additionally, a signal, for example an acoustic signal and an optical signal, may possibly be output to a user.

The idea behind the invention is not limited to the exemplary embodiments described above but can also be implemented in another manner.

In particular, a plug connector part of the described type is in principle not limited to the use at a charging system for charging an electric vehicle. A plug connector part of the described type can, for example, be used wherever a secure connection between plug connector parts is desired.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Vehicle
2 Charging station
3 Charging cable
30, 31 Mating plug connector part
300 Plug-in segment
301 Wall
4 Plug connector part (charging socket)
40 Housing part
400, 401 Plug-in segment
402 Intermediate space
403 Aperture segment
404-406 Wall
41, 42 Electrical contact element
43 Fastening device
430 Fastening opening
431 Shoulder
432 Strut element
44 Fastening element
440 Head
441 Shaft
45 Locking device
450 Locking element
451 Actuating drive
46 Support assembly
5 Authorization device
6 Sensor device
60 Active element
600 Spring arm
601 Support segment
602 Connection segment
603 Path limiting segment
604 Punch segment
605 Abutment element
61 Sensor
62 Receiving opening
63 Sealing element
7 Control device
E Plug-in direction
FC, FH Force
N User

1. A plug connector part for plug-in connection to an associated mating plug connector part, comprising:
a housing part connectable in a plug-in manner to the mating plug connector part;
a locking device configured to lock the housing part to the mating plug connector part when the locking device is in a locked position; and
a sensor device with a sensor configured to generate a sensor signal that is dependent on a force between the plug connector part and the mating plug connector part when the locking device is in the locked position.

2. The plug connector part of claim 1, wherein the sensor comprises an FSR sensor, a piezo sensor, a capacitive sensor, or a strain gauge.

3. The plug connector part of claim 1, wherein the housing part has a wall which faces toward the mating plug connector part when the plug connector part is connected in a plug-in manner to the mating plug connector part, and
wherein the sensor device is arranged on the wall.

4. The plug connector part of claim 1, wherein the plug connector part has a fastening device configured to fasten the plug connector part to a support assembly, and
wherein the sensor device is arranged at the fastening device.

5. The plug connector part of claim 1, wherein the sensor device has an active element configured to interact with the mating plug connector part when the plug connector part is connected to the mating plug connector part.

6. The plug connector part of claim 5, wherein the sensor is arranged at the active element.

7. The plug connector part of claim 5, wherein the active element has an elastically deformable spring arm which has an abutment element configured to interact with the mating plug connector part.

8. The plug connector part of claim 7, wherein the sensor is arranged at the spring arm.

9. The plug connector part of claim 7, wherein the sensor device has a support segment,
wherein the sensor is arranged at the support segment, and
wherein the spring arm is configured to interact with the sensor.

10. A system for charging an electric vehicle comprising:
the plug connector part of claim 1; and
a control device configured to control the locking device, depending on the sensor signal generated by the sensor, to transition from the locked position to an unlocked position.

11. The system of claim 10, wherein the control device is configured to determine a measurement value indicating a force change in order to control the locking device to transition from the locked position to the unlocked position.

12. The system of claim 11, wherein the control device is configured to control the locking device to transition from the locked position into the unlocked position when the measurement value representing the force change exceeds a threshold value.

13. The system of claim 10, wherein the control device is configured to control the locking device depending on the sensor signal and depending on authorization information to authorize a user.

14. The system of claim 13, wherein the control device is configured to obtain the authorization information via an authorization device communicating wirelessly with the control device.

15. A method for operating a system for charging an electric vehicle having a plug connector part connectable in a plug-in manner to an associated mating plug connector part having a housing part connectable in a plug-in manner to the mating plug connector part and a locking device, the method comprising:
locking the housing part to the mating plug connector part;
generating, via a sensor of a sensor device of the plug connector part, a sensor signal that is dependent on a force between the plug connector part and the mating plug connector part when the locking device is in the locked position; and
controlling the locking device, depending on the sensor signal generated by the sensor, to transition from a locked position to an unlocked position.
